(19) United States
(12) Patent Application Publication
(10) Pub. No.: US 2012/0234765 A1
(43) Pub. Date: Sep. 20, 2012

(54) METHOD OF TREATMENT OF PRODUCED WATER AND RECOVERY OF IMPORTANT DIVALENT CATIONS

(75) Inventors: Arup K. SenGupta, Bethlehem, PA (US); Sudipta Sarkar, West Bengal (IN); Prasun K. Chatterjee, West Bengal (IN)

(73) Assignee: LEHIGH UNIVERSITY, Bethlehem, PA (US)

(21) Appl. No.: 13/420,262

(22) Filed: Mar. 14, 2012

Related U.S. Application Data
(60) Provisional application No. 61/452,872, filed on Mar. 15, 2011.

(51) Int. Cl. C02F 1/42; B01D 1/00; B01D 15/04; C02F 103/10

(52) U.S. Cl. 210/670; 210/681; 210/180

(57) ABSTRACT

Provided herein are systems and methods for use in wastewater treatment. In some examples, the systems and methods involve different combinations of ion exchange and membrane based systems and processes that can be used to remove radium and recover and purify barium and strontium salts to render the wastewater depleted of those regulated toxic metals. Treated wastewater having less than 12000 pCi/L of any of radium, barium or strontium is then subjected to tertiary treatment where it is subjected to processes in an evaporator/crystallizer which drives out water in the form of vapor, leaving behind salts of innocuous metals such as sodium, calcium, and magnesium, among others. In some examples, water vapor from the processes is condensed to produce water suitable for reuse, such as reuse in the hydro-fracturing process.

### CROSS REFERENCE TO RELATED APPLICATIONS

This application claims the benefit of U.S. Provisional Application No. 61/452,872, filed Mar. 15, 2011.

### BACKGROUND OF THE INVENTION

Oil and gas exploration operations in many cases produce considerable volumes of wastewater with high concentration of dissolved solids containing several types of metal cations. The large volume of wastewater with high concentration of dissolve solids is by itself an environmental hazard that has yet been adequately addressed by technology. Moreover, the metal cations, many of which are of significant commercial value, often fall in the category of regulated contaminants. Therefore, recovery and purification of the metal cations in the form of their insoluble salts and recovery of water resource for reuse are important from the perspective of process economics and sustainability, as well as environmental protection.

The process of horizontal drilling of gas wells in shale oil and gas plays using the hydro-fracturing technique requires the process water to be relatively free of metal cations capable of forming precipitates or scales. Typically, divalent and higher-valent cations are known to be the common scale formers. Reuse of the treated wastewater in the process is contingent upon the efficient removal of these scale-forming cations. Out of the constituent divalent ions in a typical wastewater from the shale and shale gas plays, radium and barium are the regulated components which need to be removed from the residual waste product formed at the end of a zero-liquid-discharge treatment process. Strontium is another significant constituent of the wastewater that poses a potential environmental threat, but is not specifically regulated at this time. The purified salts of strontium and barium have commercial values.

### SUMMARY OF INVENTION

Provided herein are systems and methods for use in wastewater treatment. In some examples, the systems and methods involve different combinations of ion exchange and membrane based systems and processes that can be used to remove radium and recover and purify barium and strontium salts to render the wastewater free from the regulated metals. Treated wastewater, devoid of radium, barium or strontium, is then subjected to tertiary treatment where it is subjected to processes in an evaporator/crystallizer which drives out water in the form of vapor, leaving behind salts of innocuous metals such as sodium, calcium, and magnesium, among others. In some examples, water vapor from the processes is condensed to produce water suitable for reuse, such as reuse in the hydro-fracturing process.

In an embodiment, a method of removing radium and recovering barium and strontium salts from contaminated wastewater is provided. This method example comprises the steps of: providing a feed wastewater containing metal cations including radium and at least one of barium or strontium; contacting the feed wastewater with a bed of a polymeric cation exchanger resin, the resin including barium sulfate salts, to thereby cause the radium in the wastewater to be adsorbed by the resin and produce a first effluent that is lower in radium than the wastewater, the first effluent optionally containing cations of any of calcium, magnesium, barium and strontium; optionally processing the first effluent to create a second effluent that is characterized by the presence of divalent cations selected from any of calcium, barium, and strontium; if the first effluent or second effluent contains barium, contacting the first or second effluent with at least one barium-removing bed comprising an acidic cation exchange resin having negatively charged fixed functional groups thereon until breakthrough of barium is detected, to thereby yield a third effluent having a lower barium content than the first effluent or second effluent; optionally, contacting the barium-removing bed with a solution containing a soluble salt of barium until breakthrough of barium is detected to provide a fourth effluent; if the third or fourth effluents contain strontium, contacting the third or fourth effluents with a strontium-removing cation exchange bed until breakthrough of strontium is detected to yield a fifth effluent, the fifth effluent having less strontium content than the third or fourth effluents; wherein, upon completion of steps a-f, the first effluent, second effluent, third effluent, fourth effluent, and fifth effluent collectively contain less than 10% of the amount of any radium, barium, or strontium present in the feed wastewater.

In another embodiment, a system is provided for removing radium and recovering barium and strontium salts from contaminated wastewater. In this system example, a system for removing toxic metals from a feed wastewater is provided, the system comprising; a feed wastewater source communicably connected to the intake of a radium removing bed, an outlet of the radium-removing bed communicably connected to the intake of a barium-removing bed; an outlet of the barium removing bed communicably connected to the intake of a strontium-removing bed, an outlet of the strontium removing bed communicably connected to a water recovery system, the water recovery system comprising at least one of an evaporator or crystallizer, whereupon, upon operation of the system by passing a feed wastewater through the system, the wastewater upon exiting the system comprises less than 10% of the content of radium, barium, and strontium that it contained before entering the system.

These and other embodiments, examples, and details are provided in the accompanying specification, claims, abstract, and figures.

### DESCRIPTION OF THE DRAWINGS

FIG. 1 is a schematic showing systems and methods for treatment of wastewater containing metal & metal ions in accordance with the present invention.

FIG. 2 is a schematic showing systems and methods for the regeneration of ion exchange columns and recovery of pure salts of important metals in accordance with the present invention.

FIG. 3(A) is an enlarged photographic view of exemplary parent HRSX cation exchanger resin beads useful in systems and methods in accordance with the present invention.

FIG. 3(B) is an enlarged photographic view of the parent HRSX beads of FIG. 1 after loading with BaSO₄ particles, the loaded beads useful in systems and methods in accordance with the present invention.

FIG. 4 is a chart illustrating total radium concentration in raw wastewater and in treated wastewater in accordance with the present invention.

FIG. 5 is a schematic showing an anion exchange reactor set-up for treatment of wastewater in accordance with the present invention

FIG. 6 is a chart illustrating sequential precipitation of sulfate salts of different metal cations in accordance with the present invention.

### DETAILED DESCRIPTION OF INVENTION

Provided herein are systems and methods for wastewater treatment involving combinations of ion exchange and membrane based processes that can be used to remove radium and to recover and purify barium and strontium salts, thereby rendering the wastewater substantially free of those regulated metals and their salts. Treated wastewater, now substantially free of any of radium, barium and/or strontium, is subsequently subjected to a tertiary treatment which drives out water in the form of vapor, leaving behind salts of innocuous metals such as sodium, calcium, and magnesium, among others. The water vapor is preferably then condensed to produce recycled water suitable for reuse in the hydro-fracturing process, among other things.

New horizontal drilling techniques and the advancement in hydraulic fracturing techniques have recently helped increase the productivity of energy extraction from previously inaccessible formations, such as extraction of natural gas from shale. Currently, both horizontal drilling and hydraulic fracturing (also referred to as “fracturing” or “fracking”) are being used in conjunction for the development of natural gas wells in the Marcellus Shale and other unconventional shale plays in Pennsylvania, West Virginia, Ohio and other states. The fracturing process is performed in different intervals. Each fracturing interval requires about 300,000 to 600,000 gallons of water, including chemical amendments. For a well having a 4,000 ft lateral length, there may be from 8 to 13 such fracturing intervals. Thus, for an average well of that size, the water requirement for hydrofracturing may be in the range of 2.4 million gallons to 7.8 million gallons. The fracturing operation takes between about two to five days, with pumping rate ranging from 1,260 to 3,000 gallons per minute at a pressure of greater than 5,000 pounds per square inch.

The chemical amendments or “additives” used in the fracturing process typically include: dilute hydrochloric acid; a biocide such as gluteraldehyde; a scale inhibitor such as ethylene glycol; a friction reducer such as potassium chloride or polyacrylamide; corrosion inhibitors; and gelling agents, among others. About 30% of the water used in the hydrofracturing operations returns back as flow-back wastewater. Thus, for a typical gas well, the extent of flow-back wastewater may range between 0.75-2.4 million gallons. Most of the fracturing water flow-back takes place within four days and the rest of the flow back water is recovered within two to four months. After this time, the water recovery from the well dramatically decreases and eventually settles down to about 1000 gallons a day.

Apart from the flow-back wastewater, there will be other wastewater streams from the well development and/or oil exploration processes, often identified as “completion water” or “production water”, among other names. Wastewater from such operations is often termed as “produced water” and typically has high concentrations of dissolved solids. Further, produced water is a term used in the oil industry to describe water that is produced along with the oil and gas. Produced water is generally water that is trapped in underground formations that is brought to the surface along with oil or gas. Because the water has been in contact with the hydrocarbon-bearing formation for centuries, it contains some of the chemical characteristics of the formation and the hydrocarbon itself It may include water from the reservoir, water injected into the formation, and any chemicals added during the production and treatment processes. Produced water is also often called “brine” and “formation water.” The major constituents of concern in produced water are: a) Salt content b) oil and grease c) inorganic and organic chemicals from the drilling operation and c) naturally occurring radioactive material (also known as “NORM”). Produced water is not a single commodity. The physical and chemical properties of produced water vary considerably depending on the geographic location of the field, the geological host formation, and the type of hydrocarbon product being produced. Produced water properties and volume can even vary throughout the lifetime of a reservoir.

With a significant volume of drilling activities taking place in unconventional shale formations such as the Marcellus Shale in Pennsylvania, the provision of sufficient water for new drilling activities and subsequent disposal of large volumes of wastewater has become a critical issue. The wastewaters produced by oil and gas well drilling, completion, and production activities normally have very high total dissolved solids (TDS) concentration and thus present some unusual and difficult problems with regard to treatment suitable enough to enable disposal to surface waters or reuse. Recent disposal activities have included co-treatment of the wastewater with the publicly owned treatment plants (POTW), or alternatively, deep well injection. However, it is unlikely that the POTWs are capable of handling all of the wastewater from the wells, especially since the drilling and well development activities are increasing rapidly in the region, and across the nation. An example of the POTW limitations was illustrated by a rapid rise in the TDS levels in the Monongahela River in Pennsylvania in 2008. That TDS rise was caused by discharge of gas well wastewaters purportedly treated by many POTWs situated along the river. Subsequently, Pennsylvania Department of Environmental Protection, (PADEP) introduced a limit of 500 mg/l for dissolved solids discharges to surface waters resulting from treatment of gas well wastewaters. This limit went into effect on Jan. 1, 2011.

In addition to the above regulation, in view of their abundance, the wastewater from shale gas drilling operations is now required to have not more than 10 mg/L of each of barium and strontium ions. This is also applicable for the precipitated salts which need to pass the Toxicity Characteristics Leaching Protocol (“TCLP”) leaching test (mandated by the EPA and PADEP, for example) in order to be used as rock salts or to avoid its labeling as a hazardous waste. With these and other new regulatory restrictions in place, management and discharge of wastewater, and especially the flow-back and produced wastewater, has become difficult and costly.

A somewhat typical composition of the hydro-fracturing flow-back wastewater in Marcellus shale is indicated in Table-1. In addition to the above major constituents there are small amount of other metals such as copper, zinc, nickel, lead and other heavy metals.

TABLE 1
A Typical Composition of produced water at Marcellus Shale

| Component | Concentration (mg/L) |
|---|---|
| Na⁺ | 34730 |
| Ca²⁺ | 14200 |
| Mg²⁺ | 1000 |
| Ba²⁺ | 5000 |
| Sr²⁺ | 3000 |
| Cl⁻ | 87000 |

Core technologies currently in use for the removal and concentration of dissolved solids vary and depend on the concentration of the TDS. For example, ion exchange is used in low-TDS waters. For TDS concentrations of up to 40,000 mg/L, reverse osmosis is a preferred method. Beyond this concentration, it is not possible to use reverse osmosis, due to the elevated osmotic pressure of the solution. A further disadvantage is that reverse osmosis would only recover a very tiny amount of water even at considerably high transmembrane pressure. Thermal distillation and evaporation is sparingly used for waters with TDS concentrations of 40,000 to 200,000 mg/L. Therefore, new and cost-effective technologies are needed to treat wastewaters, especially produced water having TDS exceeding 40,000 mg/L.

Evaporative treatment processes target the treatment result of zero-liquid discharge applications or direct discharge/reuse of partially distilled water. Evaporation systems typically require pretreatment of the scale forming constituents, and often employ a precipitation process for this purpose. If the evaporative process does not include pre-treatment due to its process configuration, for example direct heat transfer systems, then the resulting crystallized salts can become contaminated with toxic levels of leachable metals (such as radium, barium, and strontium) that require further processing before safe disposal. Any solids or salts left after treatment, if pretreated to remove the toxic elements, can be reused, such as use of rock salts to de-ice roads in the winter. Otherwise, the usual presence of a high concentration of barium and strontium in the solids or salts produced by evaporative treatment currently prevents their reuse. The disposal of the solids waste in landfills is also not sustainable because of the high potential for leaching of high concentrations of toxic metals such as barium and strontium, for example.

Furthermore, low level concentrations of radium present in the wastewater are amplified during any evaporative process. TCLP tests of several solid wastes generated from the evaporative treatment of Marcellus wastewater have produced adverse results in terms of leaching of barium and strontium, as well as radium. Indeed, those solids were required to be labeled and disposed of as hazardous waste. In some cases, radium levels in the wastewater from fracturing (and in any solids resulting from evaporative treatment) can even exceed acceptable background radiation levels. The disposal of hazardous waste, especially waste containing toxic metals, is troublesome and expensive. Therefore, the management and treatment of wastewater and waste disposal adds to the cost of exploration of shale gas, thereby seriously affecting the economic viability of the exploration activities and any benefit to the public at large. The current unmet need exists for methods and systems for treating produced water and other wastewater that contains toxic metals, for recovering the toxic metals, and for recovering water and any useful salts in a form that is environmentally safe for reuse, and for increasing the efficiency of the recovery and reuse of produced water.

The process outlined herein provides a viable alternative to conventional treatment of wastewater, such as produced water from horizontal drilling and fracturing operations. The systems and methods conceived by the inventors herein provide for treatment as well as resource recovery to reduce the total cost of water treatment, as well as reducing the environmental impact. Among other advantages, the recovery of barium and strontium in semi-pure or pure form prior to any evaporative process is economically beneficial, since salts of both barium and strontium have commercial value. From an environmental perspective, the removal and recovery of those elements, water, and other wastes allows for beneficial reuse, thereby reducing hazardous waste production and related disposal costs and environmental risks.

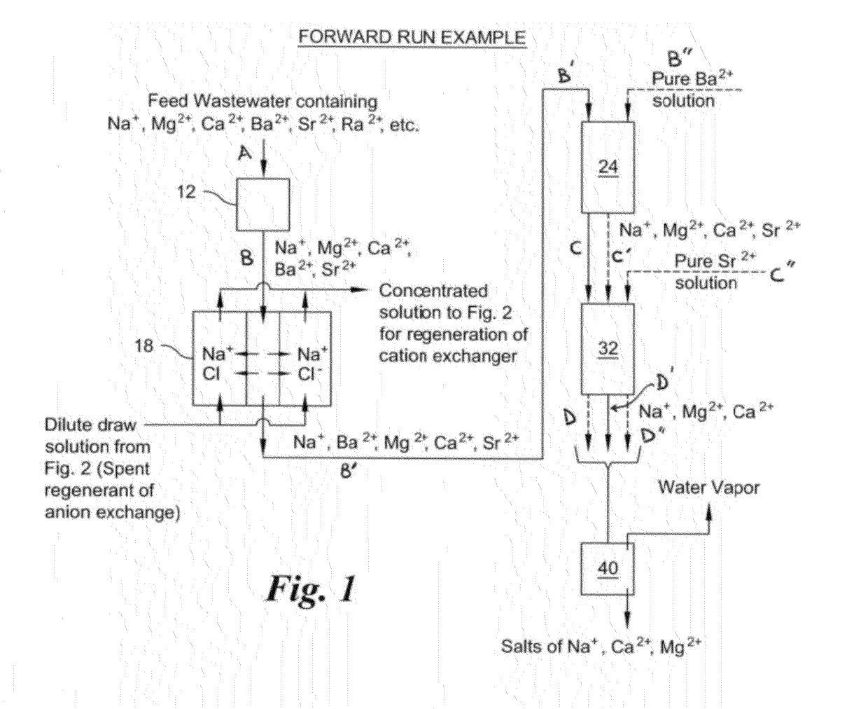

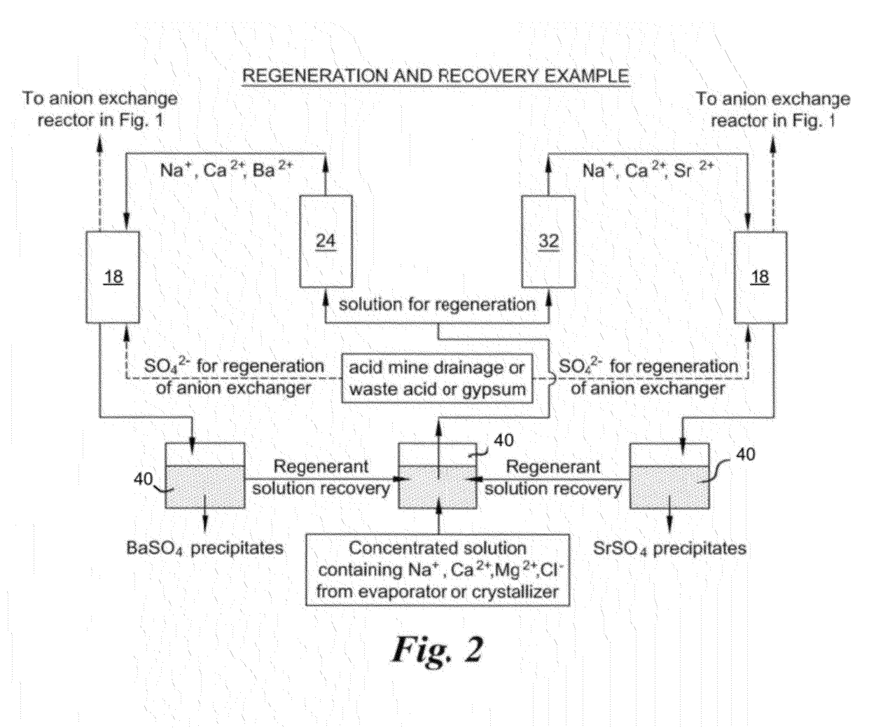

In an embodiment of the invention, a method is provided for treatment of wastewater, such as wastewater resulting from a drilling and hydrofracturing operation. In one embodiment the method comprises combinations of processes involving ion exchange, followed by concentration of removed ions and metals for recovery such as through membrane filtration, followed by chemical precipitation. These combinations are particularly suited for recovery of commercially important metals from wastewater that contains high concentrations of metal cations, among other things. The methods further render the wastewater fit for reuse. In an example, wastewater treated to remove metal cations is further treated (also described herein as “tertiary treatment”) to provide clean, recycled water (whether as vapor or liquid) that is safe to discharge to the environment, as well as innocuous salts that are substantially free of radium, strontium, or barium. A detail of the proposed treatment process is indicated in the following with the help of the schematic drawings identified as FIGS. 1 and 2.

In one embodiment of the methods disclosed herein, the method utilizes systems including cation exchange resins in columns and/or beds and concentrators (such as reactors having one or more membranes for osmotic separation, filtration, and/or concentration of fluids and dissolved solids therein). Exemplary systems are generally illustrated in the schematic diagrams of FIG. 1 and FIG. 2. As shown in those figures, an exemplary system 10 compatible with the methods includes a plurality of ion-exchange column beds 12, 24, 32. In the example shown, bed 12 is a radium-selective radium-removing ion exchange bed, bed 24 is a barium-selective barium removing ion exchange bed, and bed 32 is a strontium-selective strontium removing ion exchange bed. In the example of FIGS. 1-2, the beds 12, 24, 32 are in fluid communication in a series configuration. Further, the fluid communication arrangement preferably includes at least one concentrator, such as concentrator 18. Each concentrator is provided to control the amount of wastewater (and its constituent parts including salts, etc.) passed to the next bed 12, 24, 32. As shown and further described herein, concentrated aqueous solution from a concentrator 18 is reused in the methods and systems, such as to regenerate any of the beds 12, 24, 32 in a regeneration process.

In a “forward run” method using system 10, wastewater (labeled as A) is run through bed 12. The resulting effluent (labeled as B) from bed 12 contains very little, if any radium, but may include cations of Na, Mg, Ca, Ba, and Sr, among other things. Effluent B from bed 12, after optionally passing through concentrator 18 and becoming stream B′, is passed through barium removing bed 24. Effluent from bed 24 (labeled as C, C′, et al) contains very little, if any barium, but may include cations of Na, Mg, Ca, and Sr, among other things. Effluent from bed 24, after optionally passing through a concentrator such as concentrator 18, is passed through a strontium removing bed 32. Effluent from bed 32 (labeled as D, D′, and D″) contains very little, if any strontium, but may include cations of Na, Mg, and Ca, among other things. Effluent D, D′ and D″ is preferably collectively passed through a tertiary processing apparatus such as an evaporator or crystallizer, here shown as evaporator/crystallizer 40. As shown, water is recovered from evaporator/crystallizer 40 as water vapor, while salts of Na, Ca, and Mg, among others, are preferably recovered as precipitated salts.

In another example a wastewater containing metal cations is passed through a series of beds 12, 24, 32, each bed containing one or more of a hybrid radium-selective ion exchange resin. In an example, the resin is modified from a commercially available macroporous cation exchanger resin of spherical beads such as that designated as “C-145” available from Purolite Inc., of Philadelphia, Pa., USA. That parent C-145 resin has polystyrene structural matrix with sulfonic acid functional groups covalently attached to the matrix. The available bead size of C-145 varies, but the average bead diameter is preferably between about 400 to about 800 μm. The modification of the C-145 resin provides a hybrid radium-selective resin that is a cation exchange resin with nanoparticles of barium sulfate dispersed throughout the resin.

In an embodiment, a process for the preparation of an exemplary modified, hybrid radium-selective resin (also referred to herein as “HRSX”) is described in the following steps. Step I of the method provides for loading of Barium cation (Ba²⁺) onto parent resin (C-145 in this example) by passing 2.5 L of 2% Barium Chloride (BaCl₂) solution (W/V) through a bed of 50 g C-145 resin in a glass column at pH 3.5 and an approximate flow rate of 5 mL/min. Step II provides for rinsing of resin in the glass column, such as by passing about 1.0 L of de-ionized water through the resin in the glass column. Step III of the method provides for the simultaneous desorption of Ba²⁺ and the precipitation of Barium Sulfate (BaSO₄) within the pores (i.e., inside the resin beads) of the C-145 cation exchanger resin, such as through passage of 2.5 L 5% sodium sulfate (Na₂SO₄) solution (W/V) through the column containing the resin, such as at an approximate flow rate of 2.5 mL/min. In Step IV, the resin in the glass column is again rinsed, such as by passing about 1.0 L of deionized water through the column containing the resin. In a preferred example, the steps of loading, rinsing, desorption-precipitation, and rinsing (steps I to IV) are repeated (preferably about three times) to achieve excellent and adequate loading of Barium Sulfate (BaSO₄) inside the resin, thus yielding HRSX.

HRSX thus prepared in the laboratory is further used for removal of radium, among other cations and chemicals, from wastewater. For example, when passed through a bed of hybrid radium-selective ion exchanger (HRSX), radium ions in the wastewater preferentially replace barium ions from a solid phase barium sulfate provided inside the ion exchanger. This replacement causes the radium removed to precipitate as radium sulfate, thereby releasing barium into the wastewater. The result is a radium-depleted (preferably radium-free) wastewater.

The radium-depleted wastewater (identified as stream B in the Figures) is next conveyed to a concentrator 18, here a membrane-based osmotic reactor with sodium chloride, where the radium-depleted wastewater (effluent stream B) is introduced into a chamber enclosed by anion exchange membranes. On the other side of the membranes is a dilute salt solution containing a salt such as sodium chloride. An electrochemical gradient established across the membrane drives the chloride ions from wastewater so that they diffuse to the other side and into the dilute salt solution. Suitable anion exchange membranes include fixed positively charged functional groups which, through electrostatic repulsion, restrict the movement of cations across the membrane. Suitable anion exchange membranes compatible with the methods and systems herein include porous sheets made of organic materials such as cross linked styrene and divinyl benzene, that further include fixed positively charged functional groups such as quaternary ammonium, tertiary ammonium, secondary ammonium groups, and that, through electrostatic repulsion and other forces, restrict the movement of cations across the membrane. Suitable anion exchange membranes allow the passage of anions such as chloride, sulfate, nitrate, etc. through them. Without being limited by theory, Applicant believes that the membrane process is facilitated by electrostatic repulsion that is stronger on the divalent or higher valent cations as compared to the monovalent ones. The anions are allowed to pass through the membrane to the dilute salt solution side (also known as the “draw side”), following the chemical gradient. However, in order to maintain electroneutrality, it is desirable that equivalent amount of cations accompany the anions diffusing across the membrane. As the membrane exerts stronger repulsion on the divalent and higher valent ions, monovalent cations are preferentially partitioned to the dilute “draw” stream, leaving behind the divalent and higher valent cations. The relative equivalent concentration of divalent cations (ratio of total equivalent concentration of divalent cations to the total equivalent concentration of all the cations) compared to that of monovalent cations therefore is higher in the resultant wastewater stream (identified as effluent stream B′ in the figures) as compared to the input stream of radium-depleted wastewater (identified as effluent stream B in the Figures).

The radium-depleted wastewater stream B′ is next passed, whether in series or in parallel, through one or more beds 24, 32, etc., that include one or more cation exchange resins. The cation exchange resins, depending on the specific type of functional groups they are comprised of, have different selectivity for binding different metal cations. For commonly available cation exchange resins (such as that sold under trade name/model “C-100” and commercially available resin from Purolite Inc. of Philadelphia, Pa., USA), that C-100 characterized by having sulfonic acid functional groups fixed on polymeric matrix made up of cross-linked styrene and divinyl benzene, the selectivity sequence for the metal cations is as follows:

Ba²⁺>Sr²⁺>Ca²⁺>Mg²⁺>>Na⁺ (eqn. 1).

According to the above selectivity sequence, barium is more preferred by the cation exchange resins than strontium, followed by calcium, magnesium and sodium. Hence if a solution containing these ions is passed through a column or bed (used interchangeably herein) that is filled with cation exchange resins, the breakthrough of the cations through the columns shall occur in the sequence: sodium, magnesium, calcium, strontium and barium. For example, in barium-removing bed 24, at the breakthrough of barium, the cation exchange resin in the column will predominantly contain barium ions. Of course, that result depends somewhat on the relative distribution of the cations in the solution and the relative selectivity and total ionic concentration of the wastewater solution, among other factors known to those skilled in ion-exchange. For example, as shown in the example illustrated in FIG. 1, the radium-depleted wastewater (marked as effluent streams B, and optionally as B′) is passed through a series of cation exchange resin beds. The effluent from the first bed 24 (marked as C) will contain strontium, calcium, magnesium and sodium ions up until breakthrough of barium takes place from that first bed. At the breakthrough of barium, the bed 24 is predominantly in barium form. The cation exchange resin in bed 24 is then subjected to a dilute aqueous solution of a preferably pure barium salt such as barium chloride so that barium ions in the dilute aqueous solution displaces traces of other cations such as calcium, strontium and sodium from the resin in bed 24. The resulting solution (marked as C′) is passed through the column until there is a breakthrough of barium. Thus, the combined effluents from the barium removing bed 24 resulting from the passage of effluent B and/or B′ and the barium solution B″ combine to form effluents C, C′ and C″ that primarily contains calcium, strontium and sodium ions, with little or no Ra or Ba present. In a similar fashion, effluents C, C′, and C″ are next fed through a strontium removing bed 32 to produce effluent streams (marked as D, D′, and D″) that contains Na, Mg, and Ca ions, but very little to no Ra, Ba, or Sr.

As generally shown in FIG. 2, when the system 10 and its beds 12, 24, 32 have reached their capacity for removal of any of Ra, Ba, and Sr ions from the forward run method of FIG. 1, the system 10 can be regenerated using the water and salts recovered from the forward run methods. Regeneration methods involve running solutions through the beds 12, 24, 32 to return them to their “sulfate form” for example, as further described herein.

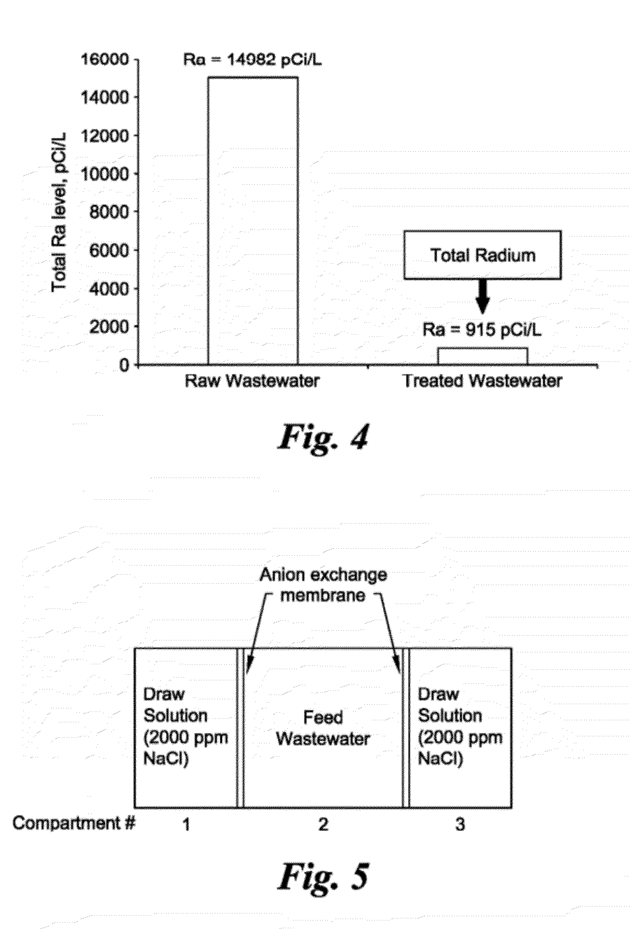

FIG. 4 is a chart illustrating total radium concentration in raw wastewater and treated wastewater processed in accordance with the present invention. FIG. 4 data was generated by using specific dosage of HRSX through batch experiments, as explained herein. The filtered sample of raw wastewater is treated in batches using an optimum dosage of 4 g/L of HRSX which is decided through a set of trials, accompanied with adequate stirring. Subsequently both samples before and after the test with HRSX are analyzed for radium content following EPA prescribed methods. The average total radium concentration in raw wastewater (obtained from Marcellus shale gas field site, PA) sample is 15000 pCi/L and this wastewater when treated in accordance with the present invention, shows total radium concentration consistently less than 1000 pCi/L (precisely around 900 pCi/L) in repetitive experiments.

In the present example, the barium-depleted effluent C, is subsequently treated to remove strontium. Treatment in this example includes passing the barium depleted effluent C from bed 24 through one or more cation exchange resin beds 32 to remove strontium. For example, strontium is preferentially adsorbed by a cation exchange resin provided in bed 32 when the effluent streams of bed 12 (marked as B and B′) are passed through bed 24, and then effluent streams C and C′ are passed from bed 24 to strontium removing cation exchange bed 32. Exemplary resins for cation exchange use in bed 32 include C-100 resin commercially available from Purolite Inc. of Philadelphia, Pa., USA, and having the properties previously described herein, and further characterized by sulfonic acid functional groups with cation exchange capacity of 2 equivalents/L, and preferably with particle size ranging from about 300 to about 1200 microns. The effluent streams from bed/column 32, marked as D, D′ and D″, contain calcium, magnesium and sodium. The effluent streams are preferably collected in a reservoir. In contrast, the cation exchange resin in bed/column 32, after passage of the streams C and C′, predominantly contains strontium along with calcium, magnesium and trace quantity of sodium. A dilute solution of strontium salt, such as strontium chloride, is passed through the bed 32 until the there is a breakthrough of strontium. At the strontium breakthrough the ion exchange resin in the second column contains only strontium ions. The effluent stream from the column 32, marked D, D′ and D″ contains calcium, magnesium and trace quantity of sodium, and is collected, preferably in the a collective reservoir holding effluent streams D, D′, and D″. The reservoir at the end of this step thus contains solution mainly with calcium, magnesium and sodium ions which are considered to be innocuous with respect to reuse, and therefore appropriate for direct heat tertiary evaporative treatment such as in evaporator/crystallizer 40.

The treated effluent in the reservoir is subjected to tertiary treatment in evaporator/crystallizer 40 where waste heat is used to evaporate out water leaving behind salts of calcium, magnesium and sodium that are safe for disposal in a conventional landfill, or that can be beneficially used elsewhere.

At the end of the “forward run” methods as depicted in FIG. 1, the two ion exchange columns 24, 32 are transformed to mainly in barium and strontium forms.

In a regeneration step, as illustrated in FIG. 2 for example, the ion exchange columns 12, 24, 32 are regenerated in such a way that the commercially important metal ions such as strontium and barium, that were segregated in the forward run methods, are recovered and precipitated in almost pure form so that the salts can be used for other commercial purposes.

FIG. 2 is a schematic diagram of an exemplary regeneration process using system 10. A concentrated salt solution from the evaporator/crystallizer 40 containing mainly sodium, calcium and magnesium is used to regenerate the cation exchanger beds 24, 32 exhausted in the forward run of FIG. 1. Regeneration transforms the cation exchange resins in the beds 24, 32 back to sodium form. The spent regenerant solutions from the beds 24, 32 produce two streams, one containing barium and the other containing strontium, in a matrix of highly concentrated sodium ions and other divalent cations as minor species. The effluent streams are separately passed through anion exchanger beds in sulfate form. The resultant effluent solutions from the anion exchange beds have then become supersaturated with respect to sulfate salts of barium or strontium. When kept standing for an adequate period of time, with or without the addition of seed crystals, pure salts of barium and strontium sulfate precipitate out of the solution phase leaving behind a solution mainly containing sodium, calcium and sulfate ions.

Table-2 provides the solubility product values of sulfate salts of different metal ions. The solubility product values of magnesium and calcium sulfate salts are orders of magnitude greater than that of barium and strontium. Low solubility of their sulfate salts ensures that almost all the barium and strontium ions present in the spent regenerant solution shall precipitate in the form of their pure sulfate salts ahead of magnesium and calcium salts. The pure salts of barium and strontium sulfate are recovered in their solid forms using appropriate filtering and physical separation procedures. The supernatant and filtrate from the recovery process mainly contain sodium chloride with trace amounts of barium, strontium and sulfate ions as impurities. The recovered solution is reused as regenerant along with concentrated solution obtained from the evaporator and/or crystallizer. The anion exchange resin beds after the passage of the solution transform to chloride form. The exhausted beds 12, 24, 32 may be regenerated back to sulfate form by subjecting it to either acid mine drainage, waste acid solution, gypsum or any other solution that is a source of sulfate ions. The spent regenerant solutions may either be sent to an evaporator or may be used in the process after suitable treatment.

TABLE 2
Solubility product values of different sulfate salts

| Salt | Chemical formula | Solubility product (Ksp) |
|---|---|---|
| Barium Sulfate | BaSO₄ | 1.08 × 10⁻¹⁰ |
| Strontium sulfate | SrSO₄ | 2.82 × 10⁻⁷ |
| Calcium sulfate | CaSO₄ | 6.3 × 10⁻⁵ |
| Magnesium sulfate | MgSO₄ | 4.67 |

### EXAMPLES

### Example 1

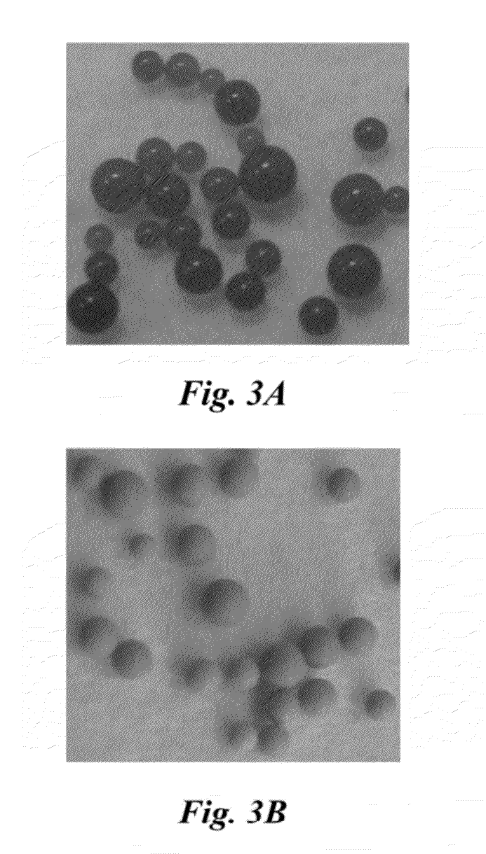

The radium removal step of the Marcellus wastewater treatment process using selected dose of hybrid radium selective ion exchanger (HRSX), as previously mentioned herein, was validated in the laboratory using wastewater obtained from Covington Unit #1 of Marcellus gas field, PA. The raw wastewater with a pH 5 was adjusted to neutral pH using 1M NaOH solution and subsequently the sample was filtered to get rid of suspended particles and dissolved iron. The filtered sample thus obtained was further contacted in batches with 2 g of HRSX (prepared from C-145 using the 4 step methods previously described herein) for 500 mL sample volume, i.e., a dosage of HRSX of 4 g/L was maintained. FIG. 3B shows enlarged view of the HRSX synthesized from cation exchange resin with polystyrene matrix and sulfonic acid functional group, identified as “C-145” (manufactured by Purolite Inc., Philadelphia, Pa., USA) which is shown in enlarged view in FIG. 3A. Both the wastewater samples before and after the experiment with HRSX were analyzed for radium content.

The results of radium analysis are indicated in the following table. FIG. 4 shows comparison of total radium (combined Ra 226 and Ra 228) level in wastewater before and after treatment. A significant amount of radium removal (>90%) is obtained.

TABLE 3
Radium concentrations of raw and treated wastewater

| | | | Wastewater treated | | | |
|---|---|---|---|---|---|---|
| Raw wastewater | | | with HRSX | | | Percent |
| Ra concentration, pCi/L | | | Ra concentration, pCi/L | | | total Ra |
| Ra-226 | Ra-228 | Total | Ra-226 | Ra-228 | Total | removal (%) |
| 14,000 | 982 | 14982 | 148 | 767 | 915 | 93.9 |

### Example 2

The wastewater after radium removal was subjected to anion exchange reactor described in FIG. 5. The draw solution used on the other side of the membrane had a concentration of 2000 ppm NaCl. The anion exchange membrane was procured from M/s Asahi Kashei Corporation, Japan. The anion exchange membrane type had the following characteristics; a) Model: NEOSEPTA ACS; b) electrical resistance: less than 3.8 ohm-cm² when measured with 0.5 N NaCl; c) burst strength: greater than 0.15 MPa; d) thickness: 0.13 mm e) functional group; quaternary ammonium. The contact time provided was about 90 hours. Table-4 below provides the distribution of different cations before and after the experiment.

TABLE 4
Distribution of different cations before and after
treatment at anion exchange membrane reactor

| | Initial condition | | Final condition | | Final condition | |
|---|---|---|---|---|---|---|
| Name | in Wastewater | | in wastewater | | in draw solution | |
| of | (Compartment#2) | | (Compartment#2) | | (Compartments #1 or 3) | |
| cation | (meq/L) | X | (meq/L) | X | (meq/L) | x |
| Na⁺ | 1983 | 0.69 | 880 | 0.57 | 1209 | 0.8 |
| Ca²⁺ | 776 | 0.27 | 580 | 0.38 | 268 | 0.18 |
| Mg²⁺ | 107 | 0.04 | 77 | 0.05 | 23 | 0.02 |
| Total | 2866 | 1.0 | 1537 | 1.0 | 1500 | 1.0 |

X = relative equivalent concentration of ion i in a solution = cᵢ/Σcᵢ, c being equivalent concentration

The above table demonstrates that the anion exchange membrane helps in partitioning of divalent cations in the central wastewater chamber (compartment #2) while sodium ions partition in the draw solution in the side chambers (compartments #1 and 3).

### Example 3

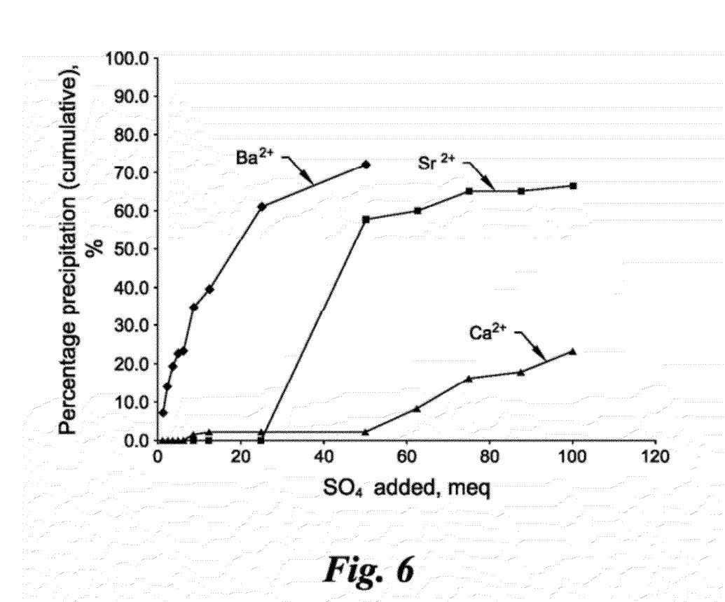

In a regeneration process, solutions containing strontium and barium ions in the background of high concentration of sodium ions with smaller concentrations of calcium and magnesium ions are recovered. Strontium and barium are obtained from the recovered solutions as their sulfate salts. When passed through anion exchanger beds in sulfate form, chloride ions in the solution are exchanged for sulfate ions. Extraction of pure salts of strontium and barium sulfate is contingent upon precipitation of pure salts separate from precipitation of sulfate salts of other impurities such as calcium or magnesium present in the wastewater. To the wastewater, 0.1M solution of sodium sulfate was added continuously and the concentration of divalent ions such as barium, strontium and calcium in the supernatant was continuously monitored. Concentration of divalent ions in the solution phase decreases due to the precipitation of their sulfate salts. FIG. 6 shows the percentage precipitation of the divalent cations in the wastewater with the addition of sulfate ions. The individual sulfate salts of the metal ions are found to have their own precipitation zones that are closely related to their solubility product values as mentioned in Table-2. Therefore, by carefully controlling the amount of sulfate ion introduced in the recovered solution, the pure sulfate salts of barium and strontium can be easily obtained from the background of other ions.

Some of the advantages of the proposed systems and processes are as follows: reduced chemical pretreatment costs due to chromatographic separation of constituents and controlled precipitation of scale forming ions; recovery of sulfate salts of different metal ions with significant commercial value; reduction in waste solids processing and disposal costs associated with toxic chemical leaching issues of the evaporator sludge; and reduced operating costs associated with water chemistry analytical testing as compared with comparable sequential precipitation process. Our process controls the water chemistry at the point of precipitation such that reagent addition is at a constant volume per regeneration cycle.

1. A method of removing radium and recovering barium and strontium salts from contaminated wastewater, the method comprising the steps of:
a. providing a feed wastewater containing metal cations including radium and at least one of barium or strontium;
b. contacting the feed wastewater with a bed of a polymeric cation exchanger resin, the resin including barium sulfate salts, to thereby cause the radium in the wastewater to be adsorbed by the resin and produce a first effluent that is lower in radium than the wastewater, the first effluent optionally containing cations of any of calcium, magnesium, barium and strontium;
c. optionally processing the first effluent to create a second effluent that is characterized by the presence of divalent cations selected from any of calcium, barium, and strontium;
d. if the first effluent or second effluent contains barium, contacting the first or second effluent with at least one barium-removing bed comprising an acidic cation exchange resin having negatively charged fixed functional groups thereon until breakthrough of barium is detected, to thereby yield a third effluent having a lower barium content than the first effluent or second effluent;
e. optionally, subsequent to step 1(d), contacting the barium-removing bed with a solution containing a soluble salt of barium until breakthrough of barium is detected to provide a fourth effluent;
f. if the third or fourth effluents contain strontium, contacting the third or fourth effluents with a strontium-removing cation exchange bed until breakthrough of strontium is detected to yield a fifth effluent, the fifth effluent having less strontium content than the third or fourth effluents;
wherein, upon completion of steps a-f, the first effluent, second effluent, third effluent, fourth effluent, and fifth effluent collectively contain less than 10% of the amount of any radium, barium, or strontium present in the feed wastewater.

2. The method of claim 1, further comprising a method of recovering barium from the barium-removing bed and regenerating the barium-removing bed, the method comprising the steps of contacting the barium-removing bed with a concentrated solution of sodium ions, the concentrated solution of sodium ions optionally further including calcium ions or magnesium ions, to yield a barium-rich effluent.

3. The method of claim 2, further comprising the step of passing the barium-rich effluent through an anion exchanger bed comprising an anion exchange resin having ammonium fixed functional groups bound with sulfate ions thereon.

4. The method of claim 3, wherein the method further comprises collecting the barium-sulfate effluent, and allowing salts of barium sulfate to precipitate out of the effluent.

5. The method of claim 1, wherein the feed wastewater has total dissolved solids of greater than about 40,000 mg/L and an average total radium concentration of greater than about 12000 pCi/L, and whereupon completion of the method, the first effluent, second effluent, third effluent, fourth effluent, and fifth effluent collectively comprise less than 1000 pCi/L of radium.

6. The method of claim 1, further comprising a method of recovering strontium from the strontium-removing bed and regenerating the strontium-removing bed, the method comprising the steps of contacting the strontium-removing bed with a concentrated solution of sodium ions, the concentrated solution of sodium ions optionally further including calcium ions or magnesium ions, to yield a strontium-rich effluent.

7. The method of claim 6, further comprising the step of passing the strontium-rich effluent through an anion exchanger bed comprising an anion exchange resin having ammonium fixed functional groups bound with sulfate ions thereon, and collecting the resulting strontium-sulfate effluent.

8. The method of claim 7, wherein the method further comprises collecting the strontium-sulfate effluent, and allowing salts of strontium sulfate to precipitate out of the strontium-sulfate effluent.

9. The method of claim 8, wherein, after precipitation of salts of strontium-sulfate, the remaining solution contains less than 12000 pCi/L of strontium.

10. The method of claim 2, further comprising a method of recovering strontium from the strontium-removing bed and regenerating the strontium-removing bed, the method comprising the steps of contacting the strontium-removing bed with a concentrated solution of sodium ions, the concentrated solution of sodium ions optionally further including calcium ions or magnesium ions, to yield a strontium-rich effluent.

11. The method of claim 10, further comprising the step of passing the strontium-rich effluent through an anion exchanger bed comprising an anion exchange resin having ammonium fixed functional groups bound with sulfate ions thereon, and collecting the resulting strontium-sulfate effluent.

12. The method of claim 11, wherein the method further comprises collecting the strontium-sulfate effluent, and allowing salts of strontium sulfate to precipitate out of the strontium-sulfate effluent

13. The method of claim 1, wherein the step of processing the first effluent to create a second effluent comprises a membrane-based treatment to remove water from the first effluent, the treatment involving applying to the membrane at least one of a pressure differential, chemical potential, or electrical potential.

14. The method of claim 5, further comprising the step of regenerating any of the anion exchange beds by contacting at least one of the anion exchange beds with a solution comprising a sulfate.

15. The method of claim 14, wherein the solution comprising a sulfate comprises at least one of acid mine drainage, a waste sulfuric acid, or a solution comprising gypsum.

16. The method of claim 1, further comprising the step of treating any of the first effluent, second effluent, third effluent, fourth effluent, and fifth effluent to recover water, and reutilizing the water in the method of claim 1.

17. The method of claim 16, wherein the step of recovering water comprises treatment in at least one of an evaporator or crystallizer so that water and salts are separated.

18. The method of claim 1, wherein the barium-removing bed comprises a cation exchange resin comprising at least one of sulfonic acid or carboxylic acid groups that have electrostatically bound sodium ions.

19. The method of claim 1, wherein the feed wastewater is generated from any of geological drilling operations, hydrofracturing, petroleum drilling operations, marcellus shale drilling operations, and processing of produced water.

20. A system for performing the method of claim 1, the system comprising;
a. a feed wastewater source communicably connected to the intake of a radium removing bed,
b. an outlet of the radium-removing bed communicably connected to the intake of a barium-removing bed;
c. an outlet of the barium removing bed communicably connected to the intake of a strontium-removing bed,
d. an outlet of the strontium removing bed communicably connected to a water recovery system, the water recovery system comprising at least one of an evaporator or crystallizer,
whereupon, upon operation of the system by passing a feed wastewater through the system, the wastewater upon exiting the system comprises less than 10% of the content of radium, barium, and strontium than it contained before entering the system.
